(19) United States
(12) Patent Application Publication
(10) Pub. No.: US 2010/0024229 A1
(43) Pub. Date: Feb. 4, 2010

(54) Measuring device

(76) Inventors: Reinhard Waibel, Berneck (CH); Andreas Winter, Feldkirch (AT)

Correspondence Address: ABELMAN, FRAYNE & SCHWAB, 666 THIRD AVENUE, 10TH FLOOR, NEW YORK, NY, 10017, US

(21) Appl. No.: 12/462,250

(22) Filed: Jul. 31, 2009

(30) Foreign Application Priority Data
Aug. 1, 2008 (DE) 10 2008 040 939.1

(51) Int. Cl. G01C 15/02

(52) U.S. Cl. 33/275 R; 33/666

(57) ABSTRACT

A measuring device (10) for determining and/or transmitting one-dimensional measurements, taken with reference to at least one end side (16) of the measuring device (10), includes a holding arrangement (17) provided on the at least one end side (16) for temporarily fixing marking element.

### BACKGROUND OF THE INVENTION

1. Field of the Invention

The present invention relates to a measuring device for determining and/or transmitting one-dimensional measurements taken with reference to at least one end side of the measuring device.

2. Description of the Prior Art

Many different tasks in the area of leveling and alignment are carried out during a construction process. In particular, when measuring or positioning a new position with respect to a reference height or reference mark, many different distances and measurements must repeatedly be determined and transmitted.

For example, a laser device, particularly a line laser device or rotary laser device, can be used to generate and show a reference plane to which subsequent measurements can eventually be related. Particularly when transferring a height and displaying a mark, or reference mark, one-dimensional measurements are often transferred with reference to the above-mentioned reference plane.

The process of height transfer is currently carried out by means of a stadia marker or a laser receiver. To this end, the dimension of the known height (e.g., reference mark) is determined with reference to a reference plane and is transferred to a new location, for example, a new wall or a new room. The stadia marker or the laser receiver is positioned in such a way that the end side of the stadia marker or the laser receiver shows the previously determined height to be marked and transferred to the object. This mark and, therefore, the transfer of the height difference is carried out by marking means, for example, a marking nail which is driven into the wall at the height of the end side.

It is disadvantageous to handle the stadia marker and/or laser receiver while detecting and maintaining the position unchanged, on the one hand, and driving in the marking nail, on the other hand. This often adversely affects accuracy, and an additional person is needed.

### SUMMARY OF THE INVENTION

Accordingly, it is the object of the present invention to provide a measuring device which facilitates marking or transferring dimensions and distances while retaining the greatest possible accuracy.

This and other objects of the present invention, which will become apparent hereinafter, are achieved by providing a measuring device as described above with the marking means being “integrated” in the measuring device. For this purpose, the measuring device according to the present invention has at least one holding element provided on at least one end side for temporarily fixing the marking means. In this way, the marking means is held in the correct position without requiring additional assistance.

Accordingly, the advantage of the measuring device according to the present invention consists in that the process of detecting the position for reference and the marking process are combined in one step. This makes it possible to carry out the process by only one person and without impairing the accuracy of the measurement.

The measuring device can comprise a stadia marker along a longitudinal extension of which the scale for measuring the distance or dimension in relation to an end side of the stadia marker is arranged to facilitate a relative measurement on the latter. The measuring device can also be a laser receiver which makes it possible to detect a reference plane or reference line displayed by a laser beam. In bright environments, a laser beam emitted by a constructional laser, particularly a rotary laser, is difficult to perceive on the object. A laser receiver used in this case permits to detect the laser beam, which is poorly visible to the human eye, on a special detection area and informs the user about the position of the laser beam in relation to the position of the laser receiver. This can be carried out by optical or acoustical means.

The measuring device advantageously includes a stadia marker on which a laser receiver is arranged so as to be displaceable. This combines the advantages of both devices. The laser receiver can be adjusted to the corresponding value on the scale of the stadia marker and inform the user as soon as the laser beam sweeps over the detection area and, therefore, the adjusted value. In addition, larger dimensions and distances can be transferred by means of the stadia marker.

The marking means are preferably designed so as to be at least partly magnetizable. This makes it possible to temporarily fix the marking means based on electromagnetic interactions. In a particularly preferred embodiment, the marking means is formed as a nail or a bolt which can be driven into the object or the wall at the appropriate location with a hammer or which leaves an easily locatable mark with its tip. Further, the user does not have to become accustomed to new marking means.

Preferably, marking means, which is at least partially magnetizable, is fixed with one or more magnets embedded in the measuring device in the area of the end side in such a way that the magnetic interaction with the marking means is sufficient to hold the marking means temporarily, but the marking means can also be detached from the measuring device with little effort. In an advantageous manner, the magnets are commercially available permanent magnets. Of course, a plurality of magnets can also be used. This increases the force which fixes the marking means. It is also possible to use electromagnets which, although more complicated, are nevertheless switchable.

It is also possible within the scope of the present invention to form a portion of the device that defines the end side, from metal or so that it is magnetizable so that magnetic marking means can be used. However, this would mean that new marking means would have to be used.

In another embodiment, the marking means is fixed. This can be carried out with forcelocking means, by a frictional engagement, with formlocking means, or a combination thereof. Mechanical fixation allows a wide variety of different marking means to be used. In particular, it is possible to use styluses and marking chalk regardless of shape.

In another embodiment, the holding means has a container for marking means in such a way that the marking means are taken from the container upon setting, and following marking means moves up from behind to take the place of the marking means that have just been set. In this way, a fast, automated operation is possible when more than one mark is to be made, in particular when the marking means makes the mark automatically, for example, in that a nail or bolt is set automatically or a stylus leaves a spot. The container is advantageously integrated in the holding means in such a way that the tip of the “actual” marking means lies in the plane of the end face. This compensates for the error which occurs as a result of the spatial extension of the marking means and of the container.

Mechanical fixation can be carried out on the end side with a wide variety of shapes of the measuring device, but it is preferable to arrange brackets along the end side to fixate the marking means. This prevents the marking means from slipping on the end side or falling off. The brackets accordingly exert a force on the marking means with a component in the plane and perpendicular to the plane.

To facilitate use of the measuring device also without marking means, the brackets are arranged in such a way that they can be swiveled, folded or generally moved in the absence of marking means in the end side. This can be realized in particular by arranging the brackets at the end side by a material bond in the form of solid state joints. It is also possible to use hinges or the like. As soon as the measuring device is arranged on the end side—as is the case, for example, when the distance from an object (wall, floor) is to be determined directly with the measuring device—it is possible to fold the brackets into suitable cutouts, grooves, notches and the like which are provided in the surface for this purpose. Accordingly, the measuring device can also easily be employed for standardized inserts.

During measurement, the value to be transferred is referenced to the end side of the measuring device so that, essentially, strictly one line or point would have to be transferred on an extension of the end side to the object. Marking means (nails, bolts, styluses or chalk) extend three-dimensionally so that the center of the marking means—to which subsequent measurements proceeding from the marked point are then related—is not located in the plane of the end side. Therefore, a groove is preferably incorporated in the end face to receive the marking means and can assist in fixing and corrects this error. This can be advantageous for magnetic fixation as well as mechanical fixation. In a particularly preferable manner, the groove is recessed in the end side in such a way that the fixed marking means are held in the end side up to the height of an “actual” marking point. This refers particularly to the tip of a nail, bolt or stylus. In this way, the accuracy of the measurement is increased because the three-dimensionality of the marking means is taken into account. Within the meaning of the invention, a groove is any type of recess which can be used to hold the marking means regardless of its eventual form.

To further minimize errors which can be caused by marking means of different thicknesses, a plurality of grooves is preferably incorporated in the end side, particularly preferably at different depths. This makes the measuring device suitable for use with many different marking means of different thickness in a versatile manner.

A plurality of holding means can be arranged at the end side. This applies to purely magnetic embodiments as well as to embodiments with purely mechanical fixation. However, combined forms—combined magnetic and mechanical forms—are also possible. Further, the advantageous embodiment of the groove receiving the marking means can be combined with all of the possibilities.

To add to the possible uses of the measuring device, the portion of the measuring device that includes the end side and the holding means(s) arranged thereon, is formed so as to be exchangeable. This is preferably carried out in that this portion of the measuring device can be fitted to a base of the measuring device, for example, in the shape of an end cap which can be inserted into an enclosure/rail forming the base. Advantageously, by means of stop edges, the different end caps always contact the base in the same way. This prevents a shifting (drift) of the measurement point, i.e., of the end side relative to the measurement scale. This portion (shoe, cap, etc.) can be fixed by a frictional engagement, formlockingly or forcelockingly. However, clamps or the like detachable fastening points are also possible.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments when read with reference to the accompanying drawings.

### BRIEF DESCRIPTION OF THE DRAWINGS

The invention will be described more fully in the following with reference to the accompanying drawings.

The drawings show:

FIG. 1 a schematic view of an end portion of a measuring device according to the present invention; and

FIGS. 2a-2c perspective views of different embodiments of an end cap showing different areas with holding means which can be arranged so as to be exchangeable in an end portion of a measuring device according to FIG. 1.

### DETAILED DESCRIPTION OF THE PREFERRED EMBODIMENTS

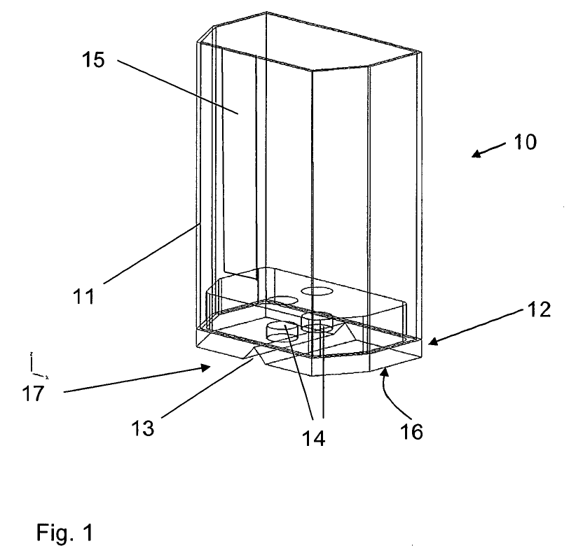

FIG. 1 shows an end area of a stadia marker 10 having a base body 11 and an end cap 12 which is arranged in the base body 10 and is frictionally held therein, so that it can easily be taken out and exchanged. The two components form a unit.

A scale 15 for reading off the distance (value) of the respective position of the stadia marker 10 from the end side 16 is located on the base body 11. In this way, this value or a height can be transferred to a position corresponding to the end side 16. Naturally, the stadia marker shown herein has a much larger extension in the z axis, but the drawing is limited to the end area of the stadia marker for the sake of clarity. Further, the stadia marker in its entirety can be formed of a plurality of members which are designed so as to displace one inside the other in a telescoping manner. Further, the stadia marker 10 can have a laser receiver which is displaceable along the scale 15. The detection and allocation of the laser beam to a value of the scale is accordingly facilitated in bright environments.

The end cap 12 is terminated by the end side 16. According to the invention, the holding means 17 for temporarily fixing marking means is located in the end cap 12. In the present case, the holding means 17 is set up for magnetizable marking means (not shown here), for example, a nail or bolt. This marking means is inserted into the groove 13 that forms the holding element 17 and is provided for this purpose in the end cap 12 and is held in this position by magnetic interaction with magnets 14 arranged above the groove 13. Being fixed in this way, the stadia marker 10 can be positioned together with the nail or bolt at a corresponding level without a need to remove the hand from the stadia marker 10 for this purpose. A sharp blow to the nail is sufficient for setting it, i.e., for marking the height. If the nail does not penetrate into the object, the nail tip at least leaves a mark which can easily be located again. The groove 13 has a shape and a depth such that the nail or bolt extends in such a way that its tip is located in the plane of the end side 16. This ensures that the mark produced by the nail is transferred to the object, i.e., the wall or floor, without errors.

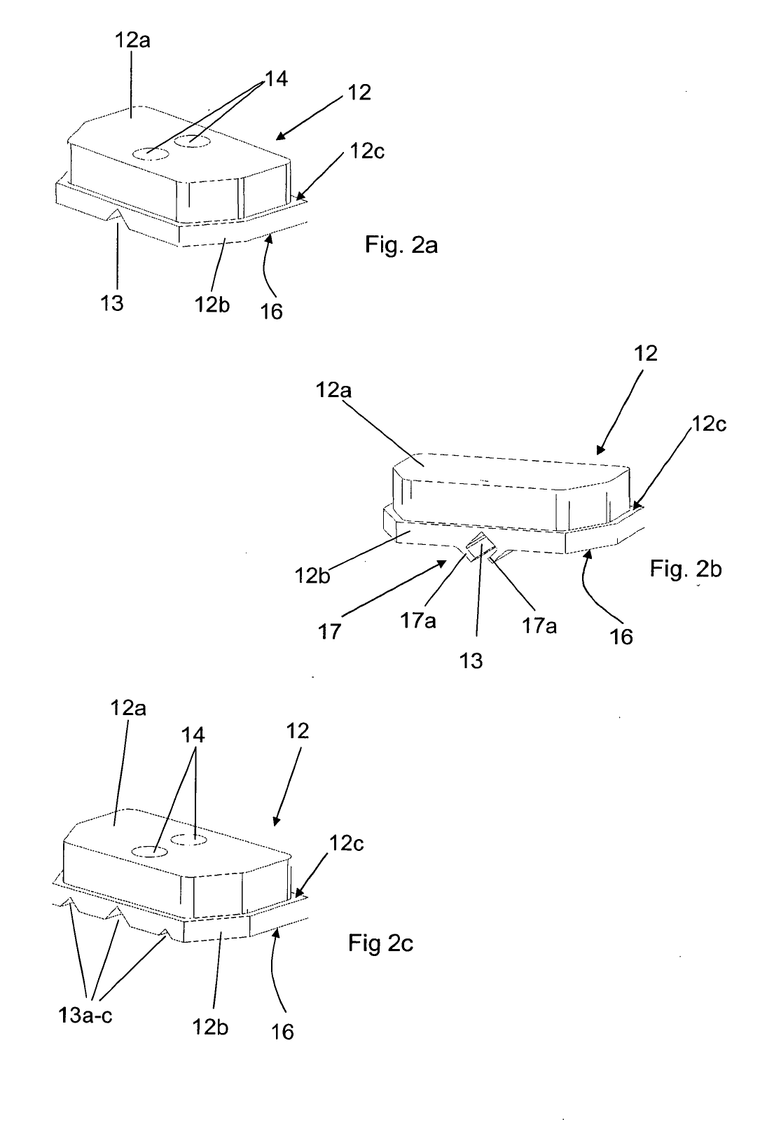

The end cap 12 shown in FIG. 1 is shown again in FIG. 2a, but without being inserted in the base 11 of the stadia marker 10. The individual areas of the end cap 12 are shown more clearly in this drawing. The cover 12b contains the groove 13 and is somewhat wider than the core 12a containing the magnets so that a circumferential stop 12c is formed. When changing the end caps 12, the core 12a is slid into the base body 11, and the frictional engagement produces a sufficient connection between the two components. The stop 12c ensures that the end cap 12 with the end side 16 always lies in the zero point with respect to the scale 15.

FIG. 2b shows an end cap 12 for non-magnetizable marking means, for example, a stylus or marking chalk. The components which are identical to those shown in FIG. 2a are identified by the same reference numbers. The holding means 17 includes groove 13 which receives the stylus or chalk in such a way that its tip is located in the plane of the end side 16 as in the example shown in FIG. 2a. Further, brackets 17a of the holding element 17, which press the stylus or chalk into the groove 13 and accordingly secure it, are arranged at both sides of the groove 13 by a material bond. The brackets 17a are designed as solid state joints at the transition to the cover 12b in such a way that they swivel into the groove in the absence of marking means as soon as the stadia marker 12 with the end cap 12 is placed on the end side. Accordingly, the use of the stadia marker according to conventional methods is not affected by the brackets. Naturally, it is also possible to use a holding means of this kind for a nail or bolt (magnetizably).

FIG. 2c shows an end cap 12 with a plurality of grooves 13a-c of different shapes and depths. Accordingly, it is possible to use marking means of different diameters with one and the same end cap and, in so doing, to ensure that their tip or center point is located in the plane of the end side. This ensures a great variability with the highest possible accuracy. Similar to FIG. 2a, two magnets 14 which fixate the magnetizable marking means in the grooves 13a-c are arranged in FIG. 2c. In the present case, the magnets 14 are arranged above the center groove 13b. But because of the strength of the magnets 14 the interaction is also sufficient for fixing marking means in the outer grooves 13a, 13c. Of course, it is also possible to allocate one or more magnets 14 to each groove 13a-c.

Irrespective of the embodiments shown above, it is, of course, also possible to integrate holding means of different types—for magnetizable and non-magnetizable marking means—in the measuring device or in the individual end caps. This can also be carried out while adapting to marking means of different thicknesses. Of course, holding means useable for magnetizable or non-magnetizable marking means can also be realized.

The preceding statements pertaining to the stadia marker 10 apply equally when the tool shown herein is a laser receiver in which a detection area is provided instead of the scale 15 for determining the position of the laser beam.

Though the present invention was shown and described with references to the preferred embodiments, such are merely illustrative of the present invention and are not to be construed as a limitation thereof and various modifications of the present invention will be apparent to those skilled in the art. It is therefore not intended that the present invention be limited to the disclosed embodiments or details thereof, and the present invention includes all variations and/or alternative embodiments within the spirit and scope of the present invention as defined by the appended claims.

What is claimed is:

1. A measuring device (10) for at least one of determining and transmitting one-dimensional measurements, taken with reference to at least one end side (16) of the measuring device (10), comprising holding means (17) provided on the at least one end side (16) for temporarily fixing marking means.

2. A measuring device (10) according to claim 1, further comprising a laser receiver.

3. A measuring device (10) according to claim 1, comprising a stadia marker.

4. A measuring device (10) according to claim 3, wherein the stadia marker includes a laser receiver.

5. A measuring device (10) according to claim 1, wherein the marking means is formed as at least partly magnetizable marking means.

6. A measuring device (10) according to claim 5, wherein the magnetizable marking means comprises one of a nail or a bolt.

7. A measuring device (10) according to claim 5, wherein the holding means (17) comprises at least one magnet (14).

8. A measuring device (10) according to claim 1, the holding means (17) mechanically fixes the marking means.

9. A measuring device (10) according to claim 1, wherein the holding means (17) comprises a container for marking means.

10. A measuring device (10) according to claim 8, wherein that the holding means (17) comprises brackets (17a) for fixing the marking means.

11. A measuring device (10) according to claim 10 wherein the brackets (17a) are arranged in such a way that they can be one of swiveled and folded into the end side (16) in absence of the marking means.

12. A measuring device (10) according to claim 1, wherein the holding means (17) comprises a groove (13) recessed in the end side (16) in such a way that the fixable marking means is held in the end side (16) at least partially up to a height of a marking point.

13. A measuring device (10) according to claim 12, wherein the holding means (17) comprises a plurality of grooves (13a-13c) incorporated in the end side (16).

14. A measuring device (10) according to claim 13, wherein the grooves have different depths.

15. A measuring device (10) according to claim 1, wherein a portion (12) of the measuring device (10) that includes the end side (16) and the holding means (13) is formed so as to be exchangeable.
